(19) United States
(12) Patent Application Publication
(10) Pub. No.: US 2026/0074591 A1
(43) Pub. Date: Mar. 12, 2026

(54) DRIVING DEVICE FOR COLD DRINK DISPENSER

(71) Applicant: Guangzhou Xin'an Trading Co., Ltd., Guangzhou (CN)

(72) Inventor: Quan Zhou, Guangzhou (CN)

(21) Appl. No.: 19/019,312

(22) Filed: Jan. 13, 2025

(30) Foreign Application Priority Data
Sep. 6, 2024 (CN) 202422201900.4

(51) Int. Cl. H02K 9/06; A47J 43/044; H02K 7/116

(52) U.S. Cl. CPC H02K 9/06; A47J 43/044; H02K 7/116

(57) ABSTRACT

Provided herein is a driving device for a cold drink dispenser including an output shaft for driving the rotating scraper to rotate, a drive motor, and a gearbox. The drive motor drives the output shaft to rotate through the gearbox. The drive motor includes an input shaft and a motor unit for driving the input shaft to rotate, the gearbox is provided with an input end for receiving the input shaft and an output end for receiving the output shaft, and one end of the input shaft is inserted into the input end, and the other end is equipped with a cooling fan. One end of the output shaft is inserted into the output end, and the other end passes through an interior of the evaporator to connect to the rotating scraper. The arrangement of the driving device ensures minimal motor usage and efficient heat dissipation.

### CROSS REFERENCE TO RELATED APPLICATIONS

The present application claims the benefit of Chinese Patent Application No. 202422201900.4 filed on Sep. 6, 2024, the contents of which are incorporated herein by reference in their entirety.

### TECHNICAL FIELD

The present disclosure relates to the technical field of a cold drink dispenser, in particular, to a driving device for a cold drink dispenser.

### BACKGROUND ART

Conventional cold drink dispenser typically uses a compressor for refrigeration, and is generally equipped with a large number of electronic components, such as control circuit boards and sensors. Therefore, household cold drink dispenser, such as ice makers for making ice drinks, is designed to have a smaller product size to facilitate home use and placement. Small-sized cold drink dispenser houses high-heat-generating components, such as motors and compressors, whose heat dissipation within the main housing affects both the cooling performance and the normal operation of the electronic components.

### SUMMARY

Embodiments of the present disclosure provide a driving device for a cold drink dispenser, which uses fewer motors and has good heat dissipation. The cold drink dispenser includes a main body, an evaporator for refrigeration, and a rotating scraper for scraping off surface deposits from the evaporator. The driving device includes an output shaft for driving the rotating scraper to rotate, a drive motor, and a gearbox, wherein the drive motor drives the output shaft to rotate through the gearbox. The drive motor includes an input shaft and a motor unit for driving the input shaft to rotate, the gearbox is provided with an input end for receiving the input shaft and an output end for receiving the output shaft, and one end of the input shaft is inserted into the input end, and the other end is equipped with a cooling fan. One end of the output shaft is inserted into the output end, and the other end passes through an interior of the evaporator to connect to the rotating scraper. The input end and the output end of the gearbox are respectively located on two side end faces of the gearbox, so that the gearbox divides the main body into a cold space, which is adjacent to the evaporator, and a heat dissipation space for mounting control components. The cooling fan is located in the heat dissipation space.

According to one or more embodiments, the gearbox includes a partitioned chamber and a set of gears installed within the partitioned chamber, and the set of gears includes at least two gears. The dimensional fitting relationship between the gear identification slots and the gears guides the installation of the gears.

According to one or more embodiments, a diameter of each gear is different, and wherein the partitioned chamber is provided with gear identification slots, each fitting one of the gears.

According to one or more embodiments, a number of the gears is increased or decreased according to shapes and sizes of the cold space and the heat dissipation space separated by the gearbox.

According to one or more embodiments, the driving device includes an auxiliary connection plate. The gearbox is connected to the main body via the auxiliary connection plate, the auxiliary connection plate is provided with insertion slots on both sides, and the main body is provided with insertion posts corresponding to the insertion slots.

According to one or more embodiments, each of two side walls of the partitioned chamber is provided with engaging lugs for engaging with the auxiliary connection plate, the auxiliary connection plate is provided with lug holders on the both sides that embrace the engaging lugs, and the lug holders are provided with embracing openings that match an outer profile of the engaging lugs, allowing the engaging lugs to be inserted.

According to one or more embodiments, each of the embracing openings is provided with a fitting post, and each of the engaging lugs is opened with a lug hole that matches the fitting post, allowing the fitting post to be inserted.

According to one or more embodiments, the driving device includes a silicon steel base composed of stacked silicon steel sheets, and wherein the silicon steel base is provided with a motor mounting hole that matches the motor unit, allowing the motor unit to be inserted and mounted.

According to one or more embodiments, an end face of the partitioned chamber is provided with a motor mounting seat for installing the drive motor, and the motor mounting seat is arranged on both sides of the silicon steel base. The motor mounting seat and the silicon steel base are respectively provided with base connection holes and support connection holes, with the base connection holes and support connection holes corresponding to each other. The base connection hole is connected to a connecting rod for supporting the silicon steel base, and the connecting rod passes through the support connection hole.

According to one or more embodiments, the silicon steel base is equipped with a pressure clamping plate, and both ends of the connecting rod are respectively connected to the pressure clamping plate and the base connection hole, so as to clamp and connect the silicon steel base to the motor mounting seat.

The technical solution of the present disclosure has the following beneficial effects:
Various embodiments provide a driving device for a cold drink dispenser, the cold drink dispenser comprising a main body, an evaporator for refrigeration, and a rotating scraper for scraping off surface deposits from the evaporator, and the driving device comprising an output shaft for driving the rotating scraper to rotate, a drive motor, and a gearbox, wherein the drive motor drives the output shaft to rotate through the gearbox, wherein the drive motor includes an input shaft and a motor unit for driving the input shaft to rotate, the gearbox is provided with an input end for receiving the input shaft and an output end for receiving the output shaft, and one end of the input shaft is inserted into the input end, and the other end is equipped with a cooling fan; and wherein one end of the output shaft is inserted into the output end, and the other end passes through an interior of the evaporator to connect to the rotating scraper. Such arrangement of the driving device allows a single motor drive source to drive both the rotating scraper and the cooling fan. Meanwhile, with the speed reduction provided by the gearbox, the rotating scraper can operate at the normal operating speed.

In the driving device, the input end and the output end of the gearbox are respectively located on two side end faces of the gearbox, so that the gearbox divides the main body into a cold space, which is adjacent to the evaporator, and a heat dissipation space for mounting control components. The cooling fan is located in the heat dissipation space to cool the heat dissipation space, while the partitioning arrangement of the gearbox significantly reduces the heat conduction from the drive motor to the evaporator.

### BRIEF DESCRIPTION OF THE DRAWINGS

FIG. 1 shows a schematic diagram of the structure of a cold drink dispenser according to one or more embodiments;

FIG. 2 shows a cross-sectional schematic diagram of a driving device for a cold drink dispenser according to one or more embodiments;

FIG. 3 shows an exploded schematic diagram of a driving device for a cold drink dispenser according to one or more embodiments.

### DETAILED DESCRIPTION

To make the objectives, technical solutions, and advantages of the present disclosure clearer, the embodiments of the present disclosure will be further described in detail below with reference to the accompanying drawings.

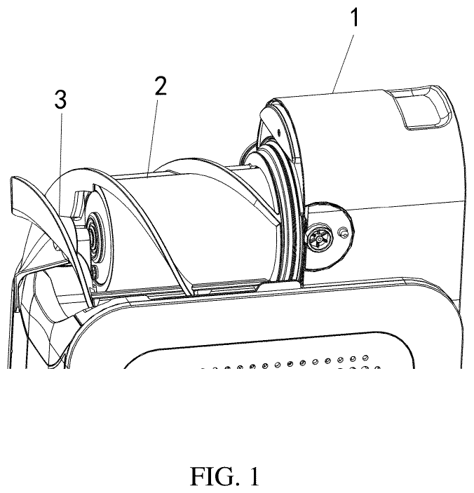

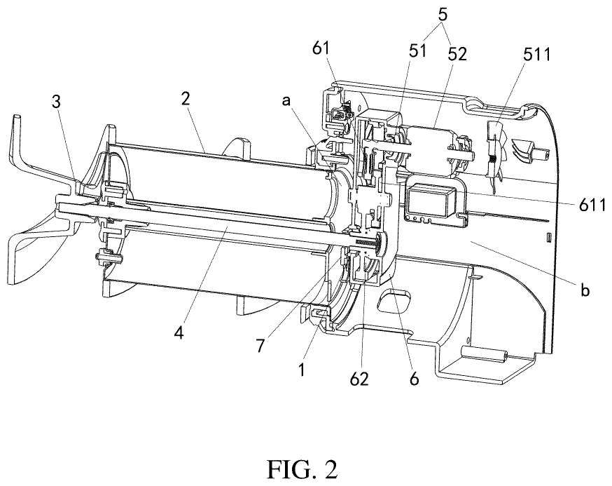

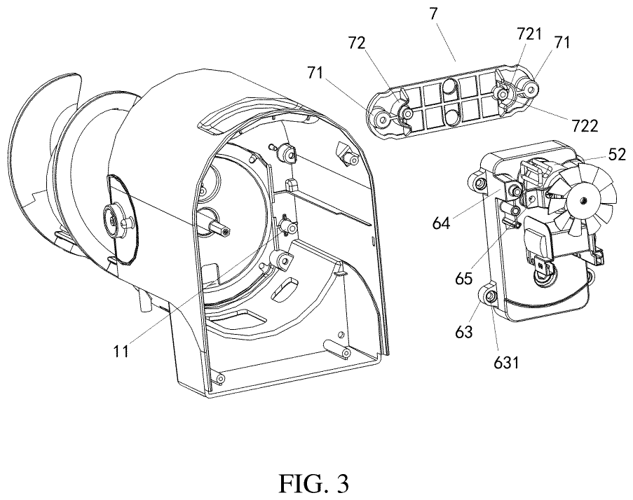

With reference to FIGS. 1, 2, and 3, embodiments of the present disclosure provide a driving device for a cold drink dispenser. The cold drink dispenser includes a main body 1, an evaporator 2 for refrigeration, and a rotating scraper 3 for scraping off surface deposits from the evaporator 2. In some examples, the surface deposits are the frost or ice layers formed on the surface of the evaporator 2. The driving device includes an output shaft 4 for driving the rotation of the rotating scraper 3, a drive motor 5, and a gearbox. The drive motor 5 drives the output shaft 4 to rotate through the gearbox.

According to one or more embodiments, the drive motor 5 includes an input shaft 51 and a motor unit 52 for driving the input shaft 51 to rotate. The gearbox is provided with an input end for receiving the input shaft 51 and an output end for receiving the output shaft 4. One end of the input shaft 51 is inserted into the input end, and the other end is equipped with a cooling fan 511. One end of the output shaft 4 is inserted into the output end, and the other end passes through the interior of the evaporator 2 to connect to the rotating scraper 3.

According to one or more embodiments, the input and output ends of the gearbox are respectively located on two side end faces of the gearbox, so that the gearbox divides the main body 1 into a cold space a, which is adjacent to the evaporator 2, and a heat dissipation space b for mounting control components. In some examples, the cooling fan 511 is located in the heat dissipation space b.

According to one or more embodiments, the gearbox includes a partitioned chamber 6 and a set of gears installed within the partitioned chamber 6. The set of gears includes at least two gears 61 to achieve a speed reduction output from the drive motor 5 to the output shaft 4.

According to one or more embodiments, the volume of the partitioned chamber 6 might be adapted depending on the actual available space inside the main body 1. When the distance between the input and output ends of the gearbox is too large, an appropriate number of gears 61 are added to transmit power, thereby avoiding the issue of a single gear 61 being too large. In some aspects, the number of gears 61 is increased or decreased according to the shape and size of the cold space a and the heat dissipation space b separated by the gearbox.

In some aspects, when an excessive number of gears 61 are provided, the diameters of the individual gears 61 can vary to facilitate assembly by production workers. The partitioned chamber 6 is provided with a plurality of gear identification slots 62, each fitting one of the gears 61. The dimensional fitting relationship between the gear identification slots 62 and the gears 61 guides the installation of the gears 61.

Since the gearbox is generally large and needs to be installed and fixed within the main body 1, which increases assembly difficulty, some embodiments of the driving device include an auxiliary connection plate 7. The gearbox is connected to the main body 1 via the auxiliary connection plate 7. The auxiliary connection plate 7 is provided with insertion slots 71 on both sides, and the main body 1 is provided with insertion posts 11 corresponding to the insertion slots 71. The preliminary connection between the gearbox and the main body 1 can be quickly completed by first connecting the gearbox to the auxiliary connection plate 7 and then inserting the insertion posts 11 into the insertion slots 71.

In some embodiments, each of two side walls of the partitioned chamber 6 is provided with engaging lugs 63 for engaging with the auxiliary connection plate 7. The auxiliary connection plate 7 is provided with lug holders 72 on its both sides that embrace the engaging lugs 63. The lug holders 72 are provided with embracing openings 721 that match the outer profile of the engaging lugs 63, allowing the engaging lugs 63 to be inserted. This facilitates the engagement between the partitioned chamber 6 and the auxiliary connection plate 7.

According to one or more embodiments, on the auxiliary connection plate 7, the embracing opening 721 is provided with a fitting post 722, and the engaging lug 63 is opened with a lug hole 631 that matches the fitting post 722, allowing the fitting post 722 to be inserted. In some examples, the insertion slots 71 and the insertion posts 11, as well as the fitting posts 722 and the lug holes 631, are all connected and fixed by forming threaded holes and using bolts for fastening.

According to one or more embodiments, the driving device includes a silicon steel base (not shown), which is composed of stacked silicon steel sheets. The silicon steel base is provided with a motor mounting hole that matches the motor unit 52, allowing the motor unit 52 to be inserted and mounted. The configuration of the silicon steel base not only improves the energy efficiency of the drive motor 5 but also ensures the stable installation of the drive motor 5.

In some embodiments, an end face of the partitioned chamber 6 is provided with a motor mounting seat 64 for installing the drive motor 5, and the motor mounting seat 64 is arranged on both sides of the silicon steel base.

In some embodiments, the motor mounting seat 64 and the silicon steel base are respectively provided with base connection holes and support connection holes, with the base connection holes and support connection holes corresponding to each other. The base connection hole is connected to a connecting rod (not shown) for supporting the silicon steel base, and the connecting rod passes through the support connection hole, thereby providing support for the silicon steel base.

In some embodiments, the silicon steel base is equipped with a pressure clamping plate 65. Both ends of the connecting rod are respectively connected to the pressure clamping plate 65 and the base connection hole, so as to clamp and connect the silicon steel base to the motor mounting seat 64.

The above-described embodiments are intended to illustrate the present disclosure. It should be appreciated that, for a person skilled in the art, various modifications and refinements can be made without departing from the principles of the present disclosure, and these modifications and refinements are also considered within the scope of the present disclosure.

What is claimed is:

1. A driving device for a cold drink dispenser, the cold drink dispenser comprising a main body, an evaporator for refrigeration, and a rotating scraper for scraping off surface deposits from the evaporator, and the driving device comprising an output shaft for driving the rotating scraper to rotate, a drive motor, and a gearbox, wherein the drive motor drives the output shaft to rotate through the gearbox,
wherein the drive motor includes an input shaft and a motor unit for driving the input shaft to rotate, the gearbox is provided with an input end for receiving the input shaft and an output end for receiving the output shaft, and one end of the input shaft is inserted into the input end, and the other end is equipped with a cooling fan;
wherein one end of the output shaft is inserted into the output end, and the other end passes through an interior of the evaporator to connect to the rotating scraper; and
wherein the input end and the output end of the gearbox are respectively located on two side end faces of the gearbox, so that the gearbox divides the main body into a cold space, which is adjacent to the evaporator, and a heat dissipation space for mounting control components, and wherein the cooling fan is located in the heat dissipation space.

2. The driving device according to claim 1, wherein the gearbox includes a partitioned chamber and a set of gears installed within the partitioned chamber, and the set of gears includes at least two gears.

3. The driving device according to claim 2, wherein a diameter of each gear is different, and wherein the partitioned chamber is provided with gear identification slots, each fitting one of the gears.

4. The driving device according to claim 3, wherein a number of the gears is increased or decreased according to shapes and sizes of the cold space and the heat dissipation space separated by the gearbox.

5. The driving device according to claim 2, further comprising an auxiliary connection plate, wherein the gearbox is connected to the main body via the auxiliary connection plate, the auxiliary connection plate is provided with insertion slots on both sides, and the main body is provided with insertion posts corresponding to the insertion slots.

6. The driving device according to claim 5, wherein each of two side walls of the partitioned chamber is provided with engaging lugs for engaging with the auxiliary connection plate, the auxiliary connection plate is provided with lug holders on the both sides that embrace the engaging lugs, and the lug holders are provided with embracing openings that match an outer profile of the engaging lugs, allowing the engaging lugs to be inserted.

7. The driving device according to claim 6, wherein each of the embracing openings is provided with a fitting post, and each of the engaging lugs is opened with a lug hole that matches the fitting post, allowing the fitting post to be inserted.

8. The driving device according to claim 1, wherein the driving device includes a silicon steel base composed of stacked silicon steel sheets, and wherein the silicon steel base is provided with a motor mounting hole that matches the motor unit, allowing the motor unit to be inserted and mounted.

9. The driving device according to claim 8, wherein an end face of the partitioned chamber is provided with a motor mounting seat for installing the drive motor, and the motor mounting seat is arranged on both sides of the silicon steel base; and
wherein the motor mounting seat and the silicon steel base are respectively provided with base connection holes and support connection holes, with the base connection holes and support connection holes corresponding to each other, and wherein the base connection hole is connected to a connecting rod for supporting the silicon steel base, and the connecting rod passes through the support connection hole.

10. The driving device according to claim 9, wherein the silicon steel base is equipped with a pressure clamping plate, and both ends of the connecting rod are respectively connected to the pressure clamping plate and the base connection hole, so as to clamp and connect the silicon steel base to the motor mounting seat.
